(19) United States
(12) Patent Application Publication
(10) Pub. No.: US 2026/0127133 A1
(43) Pub. Date: May 7, 2026

(54) SEMICONDUCTOR DEVICE AND COMMUNICATION SYSTEM

(71) Applicant: ROHM CO., LTD., Kyoto (JP)

(72) Inventor: Kei NAGAO, Kyoto (JP)

(21) Appl. No.: 19/435,031

(22) Filed: Dec. 29, 2025

Related U.S. Application Data
(63) Continuation of application No. PCT/JP2024/017790, filed on May 14, 2024.

(30) Foreign Application Priority Data
Jul. 5, 2023 (JP) 2023-110924

(51) Int. Cl. G06F 13/42; G06F 9/30

(52) U.S. Cl. CPC G06F 13/4282; G06F 9/3004; G06F 9/3013

(57) ABSTRACT

A semiconductor device includes a communication circuit configured to receive communication data transmitted from outside by serial communication and a register. The communication data includes first data that specifies a read or a write and second data that can specify a read-back when the first data specifies the write. When the first data specifies the write, the communication circuit reads and outputs to outside only the number of bytes specified in the second data out of the data at an address in the register specified in the second data.

### CROSS-REFERENCE TO RELATED APPLICATIONS

This nonprovisional application is a continuation application of International Patent Application No. PCT/JP2024/017790 filed on May 14, 2024, which claims priority to Japanese Patent Application No. 2023-110924 filed on Jul. 5, 2023, the entire contents of which are hereby incorporated by reference.

### TECHNICAL FIELD

The present disclosure relates to a semiconductor device and to a communication system.

### BACKGROUND ART

Semiconductor devices that have a serial communication function are used in various applications.

One example of circuit technology related to serial communication is disclosed in Patent Document 1.

### CITATION LIST

### Patent Literature

Patent Document 1: Japanese Unexamined Patent Application Publication No. 2017-224946

### BRIEF DESCRIPTION OF DRAWINGS

FIG. 1 is a diagram showing the configuration of a communication system according to an illustrative embodiment of the present disclosure.

FIG. 2 is a block diagram of a semiconductor device according to the embodiment of the present disclosure.

FIG. 3 is a diagram showing the data structure of reception data RX when a write (data writing) is performed with the semiconductor device as a target device.

FIG. 4 is a diagram showing a register map related to the setting of a read-back address in a register.

FIG. 5 is a diagram showing one example of a case in which a plurality of sets of read-back address data are stored in the register.

FIG. 6 is a diagram showing a register map related to the setting of the number of read-back bytes in the register.

FIG. 7 is a diagram showing one example of a case in which a plurality of sets of number-of-bytes data are stored in the register.

FIG. 8 is a diagram showing a read-back process with read-back setting data AM=1.

FIG. 9 is a diagram showing the read-back process with the read-back setting data AM=2.

FIG. 10 is a diagram showing the read-back process with the read-back setting data AM=3.

### DESCRIPTION OF EMBODIMENTS

An illustrative embodiment of the present disclosure will be described below with reference to the drawings.

### <1. Communication System>

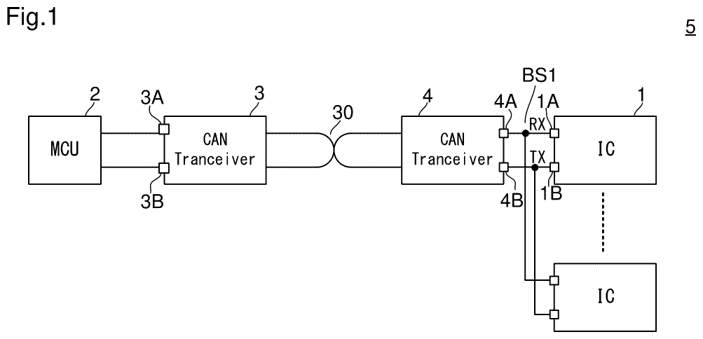

FIG. 1 is a diagram showing the configuration of a communication system 5 according to an illustrative embodiment of the present disclosure. The communication system 5 includes an MCU (micro controller unit) 2, a CAN (controller area network) transceiver 3, a CAN transceiver 4, and a plurality of semiconductor devices 1. The communication system 5 is, for one example, for onboard vehicle use.

Between the MCU 2 and the CAN transceiver 3, communication is performed by UART (universal asynchronous receiver/transmitter). UART is a protocol for exchanging serial data between two devices. In UART, bidirectional communication is performed across two lines between the transmitting side and the receiving side.

Between the CAN transceivers 3 and 4, communication is performed across a CAN bus 30. CAN is a serial communication protocol standardized in international standards such as ISO 11898.

The CAN transceiver 3 has a TXD (transmission data input) terminal 3A and an RXD (reception data output) terminal 3B. The CAN transceiver 3 outputs data input to the TXD terminal 3A to the CAN bus 30 and outputs data input from the CAN bus 30 from the RXD terminal 3B.

The CAN transceiver 4 and the semiconductor device 1 are connected together across a bus BS1. The bus BS1 is used for communication by UART. The CAN transceiver 4 has an RXD terminal 4A and a TXD terminal 4B. The CAN transceiver 4 outputs data input to the TXD terminal 4B to the CAN bus 30 and outputs data input from the CAN bus 30 from the RXD terminal 4A.

The semiconductor device 1 is an IC (integrated circuit) in which circuits for predetermined functions are integrated and is configured, for example, as an LED (light-emitting diode) driver IC. The semiconductor device 1 has an RX (reception data input) terminal 1A and a TX (transmission data output) terminal 1B.

The RX terminals 1A of the plurality of semiconductor devices 1 are all connected to the RXD terminal 4A. The TX terminals 1B of the plurality of semiconductor devices 1 are all connected to the TXD terminal 4B. Via the bus BS1, reception data RX and transmission data TX can be communicated. The reception data RX and the transmission data TX are serial data conforming to UART. The reception data RX output from the RXD terminal 4A is input to the RX terminal 1A. The transmission data TX output from the TX terminal 1B is input to the TXD terminal 4B.

### <2. Configuration of Semiconductor Device>

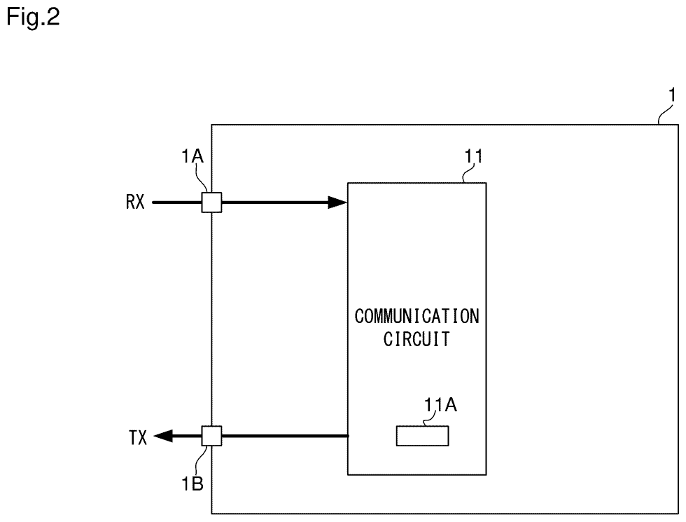

FIG. 2 is a block diagram of the semiconductor device 1 according to the embodiment of the present disclosure. The semiconductor device 1 includes a communication circuit 11. FIG. 2 illustrates only the functional blocks related to the communication function in the communication system 5; other functional blocks may also be provided. For example, if the semiconductor device 1 is an LED driver, it includes functional blocks related to LED driving.

The communication circuit 11 performs UART communication with the CAN transceiver 4. The communication circuit 11 has a register 11A. The reception data RX is input via the RX terminal 1A to the communication circuit 11. The communication circuit 11 outputs the transmission data TX via the TX terminal 1B. If a read is requested by the reception data RX, the communication circuit 11 reads data from the register 11A and transmits it as the transmission data TX. If a write is requested by the reception data RX, the communication circuit 11 writes data to the register 11A. Note however that, in this embodiment, as will be described later, even if a write is requested, the communication circuit 11 may perform a read. Reading data from the register 11A and outputting it as the transmission data TX is referred to as a read-back.

### <3. Structure of Reception Data>

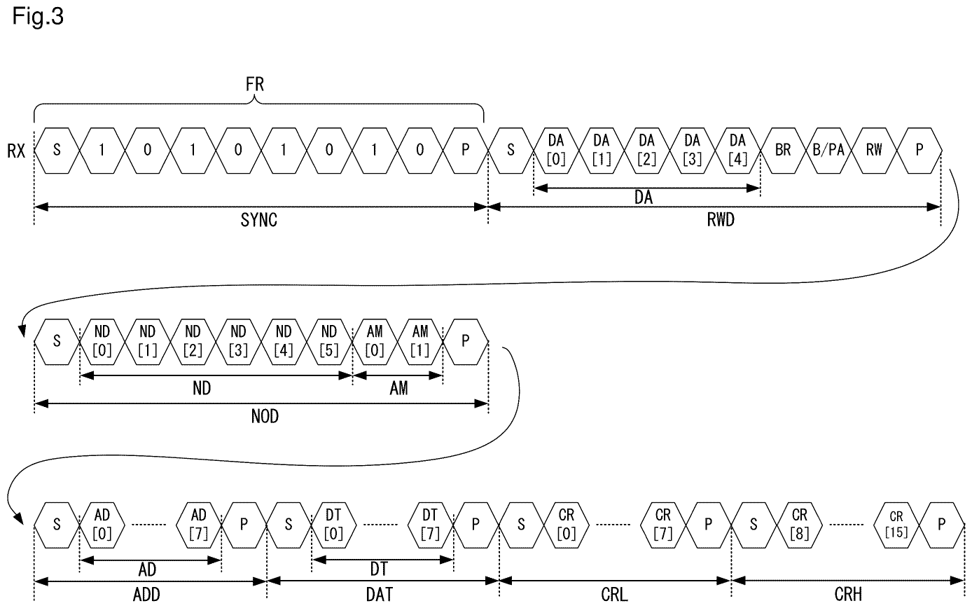

FIG. 3 is a diagram showing the data structure of the reception data RX when a write (data writing) is performed with the semiconductor device 1 as a target device.

In UART, communication is performed in data units called frames. As shown in FIG. 3, a frame FR is composed of bit data starting with a start bit S and ending with a stop bit P. The start bit S is a low level and the stop bit P is a high level. Between the start bit S and the stop bit P, bit data of a predetermined number of bits is arranged. In the example in FIG. 3, bit data of eight bits is arranged. That is, the frame FR is composed of bit data of 10 bits.

As shown in FIG. 3, the reception data RX has, in order from head to tail, a synchronization frame SYNC, a read/write and other frame RWD, a number-of-data-items frame NOD, a register address frame ADD, a data frame DAT, a CRC (cyclic redundancy check) lower frame CRL, and a CRC upper frame CRH.

The synchronization frame SYNC is bit data for setting a baud rate in the semiconductor device.

The read/write and other frame RWD includes a device address DA, a read/write bit RW, and the like.

The device address DA is bit data (five-bit data in the example in FIG. 3) indicating the address of the target device (semiconductor device). The read/write bit RW is bit data indicating a read (data reading) or a write (data writing).

The number-of-data-items frame NOD includes number-of-frames data ND and read-back setting data AM. The number-of-frames data ND is six-bit data indicating the number of frames in the data frame DAT. The read-back setting data AM is two-bit data that sets a mode of a read-back process when a write is requested by the read/write bit RW. The read-back setting data AM can take a value from 0 to 3. The read-back setting data AM may have three bits or more. The mode set by the read-back setting data AM will be described later.

The register address frame ADD includes address data AD that is bit data indicating the address in the register 11A. The data frame DAT includes write data DT which is bit data to write in the register 11A. The CRC lower and upper frames CRL and CRH are bit data indicating an error detection code added to the write data DT.

### <4. Settings Related to Read-Back>

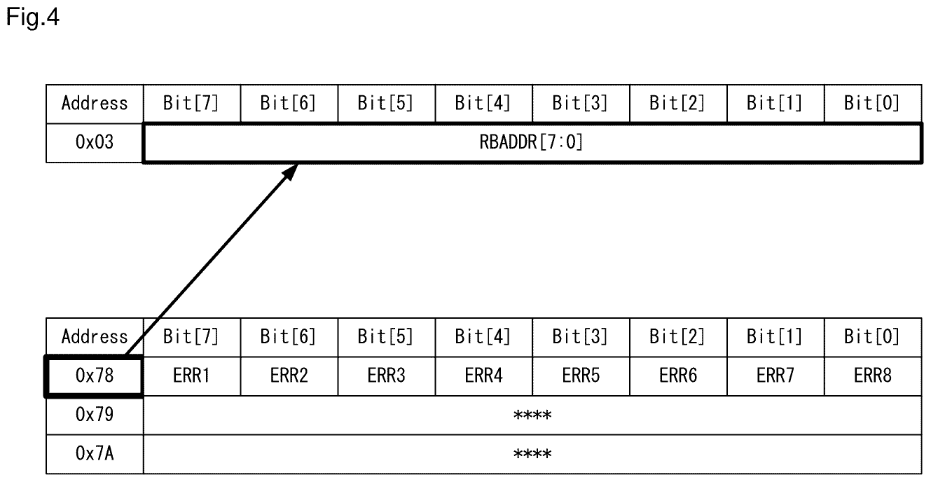

The settings related to a read-back in the register 11A will be described. FIG. 4 is a diagram showing a register map related to the setting of a read-back address in the register 11A. The register map indicates correspondence between addresses and stored data. In the register 11A, eight-bit data can be stored at one address.

As shown in upper part of FIG. 4, read-back address data RBADDR is stored at a first predetermined address (here, for example, 0x03). The read-back address data RBADDR indicates the address (read-back address) at which to read out data from the register 11A in a read-back, and is here assumed to be eight-bit data.

By contrast, the lower part of FIG. 4 shows the data stored at each of three consecutive addresses from a second predetermined address (here, for example, 0x78). Here, for example, error data ERR1 to ERR8, a set of one bits, is stored at the second predetermined address (0x78); predetermined data is stored at an address (0x79) incremented from the second specified address and also at an address (0x7A) further incremented.

By setting the second predetermined address as the read-back address in the read-back address data RBADDR, it is possible to read-back at least the data (error data ERR1 to ERR8) stored at the second predetermined address. The read-back address data RBADDR can be rewritten by UART communication and thus the read-back address is variable.

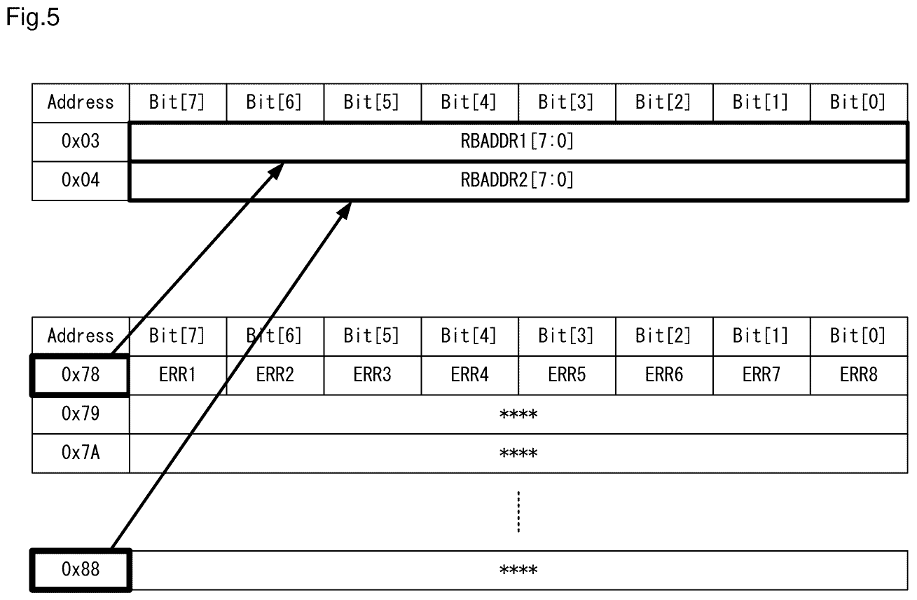

As shown in FIG. 5, a configuration is also possible that allows setting of a plurality of sets of read-back address data, such as read-back address data RBADDR1 and RBADDR2, in the register 11A. This makes it possible, as shown in FIG. 5, to set a plurality of sets of read-back addresses as by setting 0x78 in the read-back address data RBADDR1 and 0x88 in the read-back address data RBADDR2. The plurality of read-back address data can be rewritten.

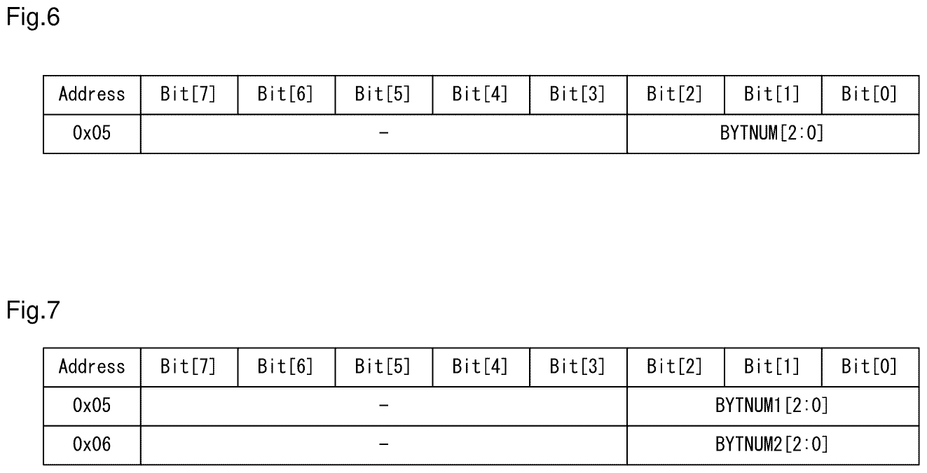

FIG. 6 is a diagram showing a register map related to the setting of the number of read-back bytes in the register 11A. As shown in FIG. 6, number-of-bytes data BYTNUM is stored at a third predetermined address (here, for example, 0x05). The number-of-bytes data BYTNUM indicates the number of bytes (the number of read-back bytes) to be read from the register 11A in a read-back, and is here assumed to be a three-bit data. For example, if BYTNUM=0, the number of read-back bytes is one; if BYTNUM=1, the number of read-back bytes is two; if BYTNUM=2, the number of read-back bytes is three, and so on. The number-of-bytes data BYTNUM can be rewritten by UART communication and thus the number of read-back bytes is variable.

As shown in FIG. 7, a configuration is also possible that allows setting of a plurality of sets of byte number data such as BYTNUM1 and BYTNUM2 in the register 11A. It is then possible to set a plurality of numbers of read-back bytes. The plurality of sets of byte number data can be rewritten.

### <5. As to Read-back Process>

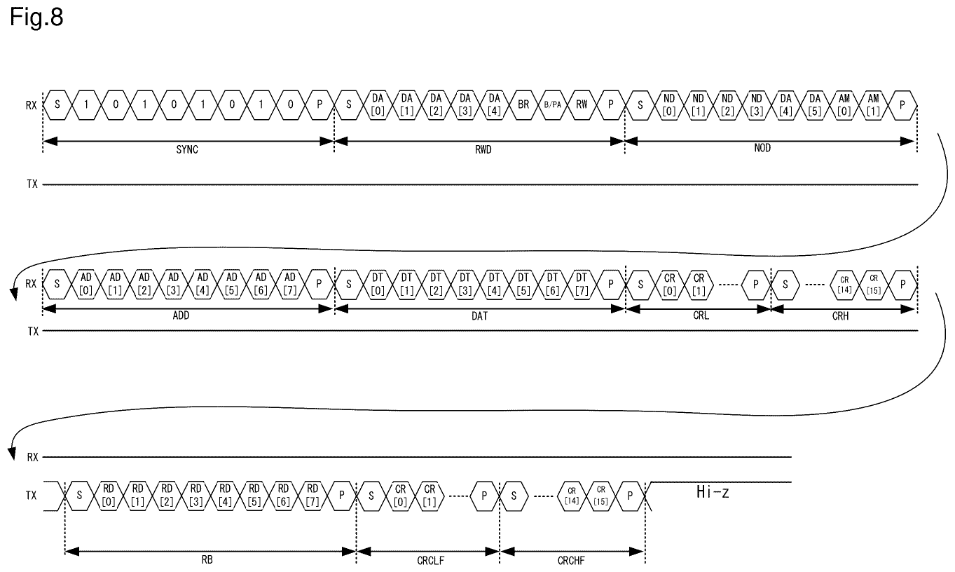

Next, the read-back process performed in the semiconductor device 1 will be described with reference to FIGS. 8 to 10. FIGS. 8 to 10 each show the reception data RX input to the communication circuit 11 and the transmission data TX output from the communication circuit 11. FIGS. 8 to 10 all show a case where a write is requested by the read/write bit RW.

FIG. 8 shows a case where, in the reception data RX, the read-back setting data AM is set such that AM=1. Here, AM=1 indicates the setting of the mode of the read-back process for reading one-byte data from the read-back address set in the read-back address data RBADDR (FIG. 4). The number of bytes here, specifically, one byte, may be set fixedly or may be set, for example, in the number-of-bytes data BYTNUM1 (FIG. 7).

When the reception data RX is input up to the CRC upper frame CRH, the communication circuit 11 performs a write to the register 11A based on the write data DT included in the reception data RX. Also, the communication circuit 11 reads one-byte data from the read-back address set in the read-back address data RBADDR and outputs the transmission data TX as a read-back frame RB. The read-back frame RB includes the read-back data RD [7:0] (one-byte) so read. As shown in FIG. 4, if 0x78 is set in the read-back address data RBADDR, the error data ERR1 to ERR8 is the read-back data RD.

After outputting the read-back frame RB, the communication circuit 11 outputs a CRC lower frame CRCLF and a CRC upper frame CRCHF as the transmission data TX. The CRC lower and upper frames CRCLF and CRCHF are bit data indicating an error detection code added to the read-back data RD. After that, the transmission data TX goes into a high-impedance state (Hi-z).

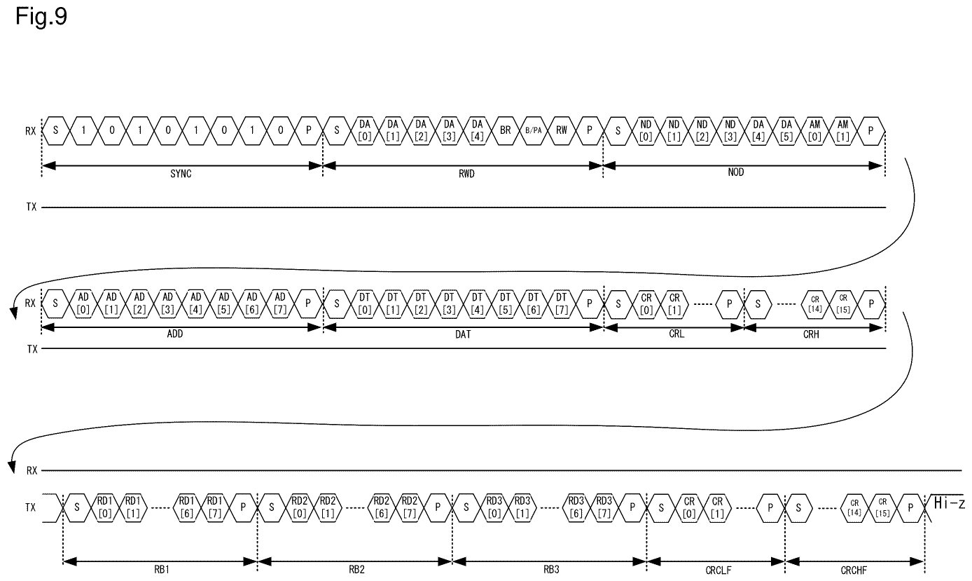

FIG. 9 shows a case where, in the reception data RX, the read-back setting data AM is set such that AM=2. Here, AM=2 indicates the setting of the mode of the read-back process for reading three-byte data from the read-back address set in the read-back address data RBADDR (FIG. 4). The number of bytes here, specifically, three bytes, may be set fixedly or may be set, for example, in the number-of-bytes data BYTNUM2 (FIG. 7). The three-byte data is the data stored at three consecutive addresses from the read-back address set in the read-back address data RBADDR and is, in the example in FIG. 4, the data (such as error data) stored at 0x78, 0x79, and 0x7A.

In the case in FIG. 9, as in FIG. 8, the communication circuit 11 performs a write to the register 11A based on the write data DT. Also the communication circuit 11 reads three-byte data from the read-back address set in the read-back address data RBADDR and outputs the transmission data TX as read-back frames RB1, RB2, and RB3. The read-back frames RB1, RB2, and RB3 respectively include the read-back data RD1, RD2, and RD3 so read. In the example in FIG. 4, the data stored at 0x78 is the read-back data RD1, the data stored at 0x79 is the read-back data RD2, and the data stored at 0x7A is the read-back data RD3.

After outputting the read-back frames RB1, RB2, and RB3, the communication circuit 11 outputs a CRC lower frame CRCLF and a CRC upper frame CRCHF as the transmission data TX. The CRC lower and upper frames CRCLF and CRCHF are bit data indicating an error detection code added to the read-back data RD1, RD2, and RD3.

When, for example as shown in FIG. 5, a plurality of sets of read-back address data are set, based on the value of the read-back setting data AM, the communication circuit 11 may change the read-back address data it refers to. For example, it can refer to, if AM=1, the read-back address data ABADDR1 and, if AM=2, the read-back address data ABADDR2.

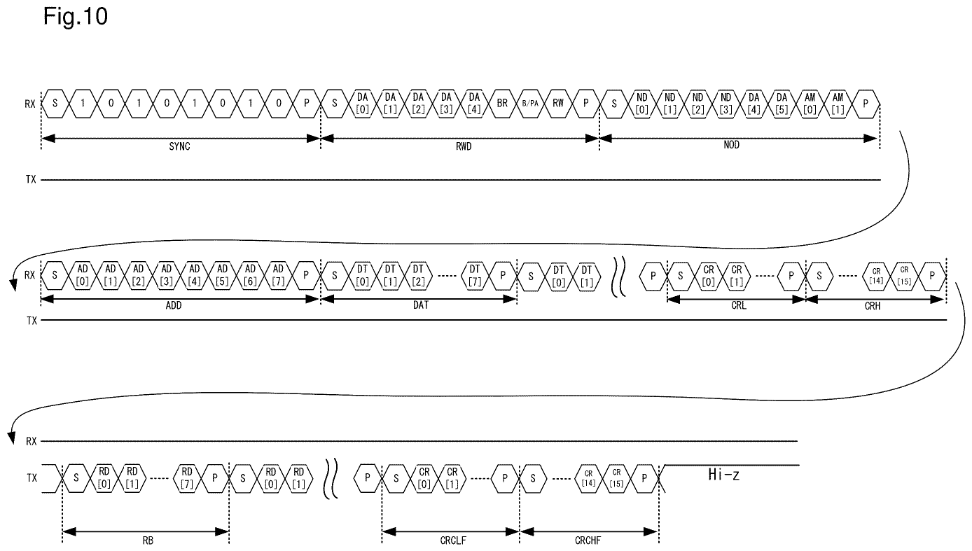

FIG. 10 shows a case where, in the reception data RX, the read-back setting data AM is set such that AM=3. Here, AM=3 indicates the setting of the mode of the read-back process for reading written data.

In the case in FIG. 10, a write to the register 11A is performed based on the write data DT included in the reception data RX at the address specified in the address data AD included in the reception data RX. The number of data frames DAT including the write data DT is specified in the number-of-frames data ND included in the number-of-data-items frame NOD. According to the number specified in the number-of-frames data ND, a write is performed at consecutive addresses from the address specified in the address data AD.

After the write, the communication circuit 11 reads from the register 11A the data corresponding to the number of bytes specified in the number-of-frames data ND starting at the address specified in the address data AD and outputs the transmission data TX as the read-back frame RB. At this time, data is read at consecutive addresses from the address specified in the address data AD. The number of read-back frames RB is the number specified in the number-of-frames data ND.

After outputting the read-back frame RB, the communication circuit 11 outputs a CRC lower frame CRCLF and a CRC upper frame CRCHF as the transmission data TX. The CRC lower and upper frames CRCLF and CRCHF are bit data indicating an error detection code added to the read-back data RD. After that, the transmission data TX goes into a high-impedance state (Hi-z).

In this mode of the read-back process, the data written to the register 11A can be read back.

By setting AM=0, it is possible to specify a normal mode in which no read-back is performed. In this case, no read-back is performed and only a write is performed.

### <6. Other Modifications>

The various technical features disclosed herein can be modified from the embodiments described above in various ways without departure from the spirit of the technical ingenuity. It should be understood that the above-described embodiments are in every aspect illustrative and not restrictive. The technical scope of the present disclosure is defined not by the description of the embodiments given above but by the appended claims, and encompasses any modifications made without departure from the scope and sense equivalent to those claims.

### <7. Notes>

As described above, according to one aspect of the present disclosure, a semiconductor device (1) includes a communication circuit (11) configured to receive communication data (RX) transmitted from outside by serial communication and a register (11A). The communication data includes first data (RW) that specifies a read or a write and second data (AM) that can specify a read-back when the first data specifies the write. When the first data specifies the write, the communication circuit reads and outputs to outside only the number of bytes specified in the second data out of the data at an address in the register specified in the second data. (A first configuration.) With this configuration, when the communication data specifies the write, it is possible to read only a desired number of bytes from a desired address, so even when the write is requested by serial communication, it is possible to address the challenge of effectively performing a read.

In the first configuration described above, the address specified in the second data (AM) may be an address set in predetermined address data (RBADDR) stored in the register. (A second configuration.) In the second configuration described above, a plurality of sets of the address data (RBADDR1, RBADDR2) may be stored in the register, and according to the second data, the address data may selected from the plurality of sets of the address data. (A third configuration.)

In the second or third configurations described above, in the register, error data (ERR1 to ERR8) may be stored at the address set in the predetermined address data (RBADDR). (A fourth configuration.) In any one of the second to fourth configurations described above, the communication circuit may read the number of bytes out of the data stored at a plurality of consecutive addresses starting at the address set in the predetermined address data (RBADDR). (A fifth configuration.)

In any one of the first to fifth configurations described above, the number of bytes specified in the second data (AM) may be a number of bytes set in predetermined number-of-bytes data (BYTNUM) stored in the register. (A sixth configuration.)

In the sixth configurations described above, a plurality of sets of the number-of-bytes data (BYTNUM1, BYTNUM2) may be stored in the register, and according to the second data, the number-of-bytes data may selected from the plurality of sets of the number-of-bytes data. (A seventh configuration.)

In any one of the first to seventh configurations described above, when the first data specifies the write, the communication circuit may perform a write to the register based on write data (DT) included in the communication data, and the second data (AM) may specify a mode in which data written to the register is read and transmitted to outside. (An eighth configuration.)

In any one of the first to eighth configurations described above, the second data (AM) may specify a normal mode in which no read-back is performed. (A ninth configuration.)

In any one of the first to ninth configurations described above, the communication data may include a second frame (NOD) indicating the number of frames in a first frame (DAT) including write data (DT), and the second data (AM) may be included in the second frame. (A tenth configuration.)

In the tenth configurations described above, the serial communication may be UART communication. (An eleventh configuration.)

According to another aspect of the present disclosure, a communication system (5) includes the semiconductor device (1) according to any one of the first to eleventh configurations, and a transmission device (4) configured to transmit the communication data. (A twelfth configuration.)

### INDUSTRIAL APPLICABILITY

The present disclosure finds applications in, for example, communication systems for onboard vehicle use.

### REFERENCE SIGNS LIST

1 semiconductor device

1A RX terminal

1B TX terminal

3 CAN transceiver

3A TXD terminal

3B RXD terminal

4 CAN transceiver

4A RXD terminal

4B TXD terminal

5 communication system

11 communication circuit

11A register

30 CAN bus

1. A semiconductor device comprising:
a communication circuit configured to receive communication data transmitted from outside by serial communication, and
a register,
wherein
the communication data includes:
first data that specifies a read or a write, and
second data that can specify a read-back when the first data specifies the write, and
when the first data specifies the write, the communication circuit reads and outputs to outside only a number of bytes specified in the second data out of data at an address in the register specified in the second data.

2. The semiconductor device according to claim 1, wherein
the address specified in the second data is an address set in predetermined address data stored in the register.

3. The semiconductor device according to claim 2, wherein
a plurality of sets of the address data are stored in the register, and
according to the second data, the address data is selected from the plurality of sets of the address data.

4. The semiconductor device according to claim 2, wherein
in the register, error data is stored at the address set in the predetermined address data.

5. The semiconductor device according to claim 2, wherein
the communication circuit reads the number of bytes out of the data stored at a plurality of consecutive addresses starting at the address set in the predetermined address data.

6. The semiconductor device according to claim 1, wherein
the number of bytes specified in the second data is a number of bytes set in predetermined number-of-bytes data stored in the register.

7. The semiconductor device according to claim 6, wherein
a plurality of sets of the number-of-bytes data are stored in the register, and
according to the second data, the number-of-bytes data is selected from the plurality of sets of the number-of-bytes data.

8. The semiconductor device according to claim 1, wherein
when the first data specifies the write, the communication circuit performs a write to the register based on write data included in the communication data, and
the second data can specify a mode in which data written to the register is read and transmitted to outside.

9. The semiconductor device according to claim 1, wherein
the second data can specify a normal mode in which no read-back is performed.

10. The semiconductor device according to claim 1, wherein
the communication data includes a second frame indicating a number of frames in a first frame including write data, and
the second data is included in the second frame.

11. The semiconductor device according to claim 10, wherein
the serial communication is UART communication.

12. A communication system comprising:
the semiconductor device according to claim 1, and
a transmission device configured to transmit the communication data.
